(19) United States
(12) Patent Application Publication
(10) Pub. No.: US 2007/0110644 A1
(43) Pub. Date: May 17, 2007

(54) System for manufacturing a fullerene derivative and method for manufacturing

(76) Inventors: Yasuhiko Kasama, Sendai-shi (JP); Kenji Omote, Sendai-shi (JP); Kuniyoshi Yokoh, Sendai-shi (JP)

Correspondence Address: YOUNG & THOMPSON, 745 SOUTH 23RD STREET, 2ND FLOOR, ARLINGTON, VA, 22202, US

(21) Appl. No.: 10/581,441

(22) PCT Filed: Dec. 3, 2004
(86) PCT No.: PCT/JP04/18057

§ 371 Date: Jan. 12, 2007

(30) Foreign Application Priority Data
Dec. 3, 2003 (JP) 2003-404540

(51) Int. Cl. C01B 21/06; B01J 19/08

(52) U.S. Cl. 422/186; 423/445 B; 423/364; 977/734; 422/186.04

(57) ABSTRACT

Provided is a system for manufacturing a fullerene derivative whereby it is possible to heat electrons in a plasma highly efficiently and to attain the improved yield of a fullerene derivative. The system can generate a high electron temperature plasma using plasma generating elements including a microwave generator, mirror field generating coil, and four phased helical antenna. Thus, with this system, the production efficiency of the ions of an atom which acts as a moiety in the production of a fullerene derivative is improved, and the yield of a fullerene derivative is also improved.

### TECHNICAL FIELD

The present invention relates to a system for manufacturing a fullerene derivative where a gas containing an atom acting as a moiety is introduced in a vacuum vessel, the flow of a plasma comprised of the atom acting as a moiety is generated in the vacuum vessel, and a fullerene is introduced into the flow of plasma so that a fullerene derivative is allowed to deposit on a substrate.

### BACKGROUND ART

Patent-related reference 1: WO 2004/060799

A technique responsible for the manufacture of an atom-doped fullerene which is a sort of fullerene derivative is proposed by the authors of Patent-related reference 1.

This technique enables the manufacture of an atom-doped fullerene by using a system where a dopant atom is transformed into plasma by RF induction in a vacuum vessel, a jet of fullerene is applied to the flow of plasma comprised of the dopant atom, and resulting endohedral fullerenes are allowed to deposit on a potential body located downstream of the plasma flow.

### DISCLOSURE OF THE INVENTION

### Problem to be Solved by the Invention

However, if a system configured as described above is used to manufacture a nitrogen-doped fullerene, its yield is very low which is problematic.

Nitrogen molecule N₂ which serves as a source of the dopant atom will require, for it to be reduced to single atoms, dissociation energy (N₂->N) of about 9.8 eV. For a nitrogen atom to be ionized (N->N+), the nitrogen atom will require ionization energy of about 14.5 eV. Therefore, plasma where nitrogen molecules are transformed into nitrogen ions must have energy of at least 15 eV in terms of its electron temperature. However, it is difficult for the system configured as described above to securely provide 15 eV for energy necessary for ionizing nitrogen molecule.

### MEANS FOR SOLVING PROBLEMS

With a view to solve the above problem, the present invention aims to provide a system for manufacturing a fullerene derivative capable of heating electrons in plasma at high efficiency, and thereby achieving the high yield production of a fullerene derivative, and a method adapted for the system.

A first aspect of the invention relates to a system for manufacturing a fullerene derivative comprising means for generating high electron temperature plasma whose electron energy is kept 15 to 50 eV in order to generate a positive monovalent ion M⁺ from a gas containing an atom M which acts as a moiety in the production of a fullerene derivative, fullerene introducing means for introducing a fullerene into plasma comprised of M⁺ and electrons to produce a fullerene ion, and a deposition substrate where a fullerene derivative produced as a result of reaction between the fullerene ion and M⁺ is allowed to deposit.

A second aspect of the invention relates to a system for manufacturing a fullerene derivative comprising means for generating high electron temperature plasma whose electron energy is kept 15 to 50 eV in order to generate a positive monovalent ion M⁺ from a gas containing an atom M which acts as a moiety in the production of a fullerene derivative, fullerene introducing means for introducing a fullerene, and a deposition substrate, wherein plasma comprised of M⁺ is driven against the deposition substrate while at the same time fullerene ejected via the fullerene introducing means is allowed to impinge onto the deposition substrate so that M⁺ and fullerene react with each other to produce a fullerene derivative which deposits on the deposition substrate.

A third aspect of the invention relates to a system as described in relation to the first or second aspect for manufacturing a fullerene derivative wherein the high electron temperature plasma generating means comprises at least a pair of coils for generating a mirror field which prohibits the dispersion of positive ions produced.

A fourth aspect of the invention relates to a system as described in the first or second aspect for manufacturing a fullerene derivative wherein the high electron temperature plasma generating means comprises at least a pair of coils for generating a mirror field which prohibits the dispersion of positive ions produced, and a four phased helical antenna located between the pair of coils.

A fifth aspect of the invention relates to a system as described in the first or second aspect for manufacturing a fullerene derivative wherein the high electron temperature plasma generating means comprises gas introducing means, a microwave generator for exciting gas to produce positive ions therefrom, a pair of coils for generating a mirror field which prohibits dispersion of the positive ions produced, and a four phased helical antenna located between the pair of coils.

A sixth aspect of the invention relates to a system as described in any one of the first to fifth aspects for manufacturing a fullerene derivative further comprising electron energy control means for controlling the energy of electrons in a plasma to be in the range of 1 to 10 eV, the electron energy control means being located downstream of the high electron temperature plasma generating means in terms of the flow of plasma.

A seventh aspect of the invention relates to a system as described in the sixth aspect for manufacturing a fullerene derivative wherein the electron energy control means controls the energy of electrons by applying a control voltage to an electrode located upstream of the fullerene introducing means in terms of the flow of plasma.

An eighth aspect of the invention relates to a method for manufacturing a fullerene derivative employed by a system as described in any one of the first to seventh aspects for manufacturing a fullerene derivative.

A ninth aspect of the invention relates to a method as described in the eighth aspect for manufacturing a fullerene derivative wherein the atom to act as a moiety in the production of a fullerene derivative is nitrogen, hydrogen, argon, helium, neon, or boron.

A tenth aspect of the invention relates to a method as described in the eighth or ninth aspect for manufacturing a fullerene derivative wherein the fullerene derivative is an endohedral fullerene or heterofullerene.

An eleventh aspect of the invention relates to a method as described in the eighth aspect for manufacturing a fullerene derivative wherein the fullerene derivative is N@C₆₀, C₅₉N, or C₅₈BN.

Effect of the Invention

(1) According to a system as described in claim 1 and claim 8 for manufacturing a fullerene derivative and a method employed by the system, since the ions of an atom acting as a moiety are excited by electrons heated to a high temperature, it is possible to efficiently generate a high density plasma comprised of the ions of an atom acting as a moiety such as nitrogen, and to obtain a fullerene derivative at a high yield.

(2) According to a system as described in claim 6 to claim 8 for manufacturing a fullerene derivative and a method employed by the system, a plasma having a low electron temperature is generated whose electron temperature is controlled by electron energy controlling means located downstream of means for generating a high electron temperature plasma, and fullerene vapor is introduced into the plasma having a low electron temperature. Thus, it is possible to inhibit the generation of positive ions of fullerene and promote the efficient generation of negative ions of fullerene.

(3) According to a system as described in claim 2 to claim 8 for manufacturing a fullerene derivative and a method employed by the system, a high density plasma comprised of the ions of an atom acting as a moiety is impinged onto a deposition substrate and fullerene vapor is ejected to the plasma simultaneously. Thus, it is possible to further improve the yield of a fullerene derivative.

(4) According to a system as described in claim 3, and claim 6 to claim 8 for manufacturing a fullerene derivative and a method employed by the system, while a high density plasma comprised of the ions of an atom acting as a moiety is impinged onto a deposition substrate. (5) According to a system as described in claim 4, 5 and claim 8 for manufacturing a fullerene derivative and a method employed by the system, it is possible to efficiently excite gas containing the atom acting as a moiety, and to restrict plasma comprised of ions generated as a result of the excitation as well as electrons within a limited space by means of a mirror field. Thus, it is possible to generate a plasma containing high temperature electrons at high density.

(6) According to a system as described in claim 9 to claim 11 for manufacturing a fullerene derivative and a method employed by the system, it is possible to produce an industrial material having a singular property which has a prospect to be applied in the fields such as electronics and medicine.

### BRIEF DESCRIPTION OF THE DRAWINGS

FIG. 1 is a schematic diagram outlining a system of the invention for manufacturing a fullerene derivative.

FIG. 2 is a sectional view of the inventive system for manufacturing a fullerene derivative.

FIGS. 3(a) and 3(b) represent a sectional view of respective inventive systems for manufacturing a fullerene derivative.

FIG. 4 is a graph representing the cross-sectional area of electron attached fullerene as a function of electron energy.

FIG. 5 shows a list of data specifying the system where argon gas is used.

FIG. 6 represents mass spectroscopic data of a deposition membrane.

FIG. 7 plots the intensity ratio I(722)/I(720) based on the mass spectroscopy of a deposition membrane.

### REFERENCE NUMERALS

21, 41: Fullerene derivative manufacturing system

2, 22, 42: High electron temperature plasma generating chamber.

3, 23, 43: Fullerene derivative generating chamber.

4, 24, 44: Vacuum pump

5, 25, 45: Microwave generator

6, 26, 46: Gas introducing pipe

71, 72, 271, 272, 471, 472: Electromagnetic coil

8, 28, 48: PMH antenna

9, 29, 49: Oven for sublimating fullerene

10, 30, 50: Fullerene introducing pipe

11, 12, 31, 32, 51, 52: Electromagnetic coil

13, 33, 53: Fullerene derivative deposition membrane

14, 34, 54: Deposition substrate

15, 35, 55: Voltage source for biasing deposition substrate

16, 35, 56: Plasma having a high electron temperature

17, 57: Low electron temperature plasma

18, 58: Control electrode

19, 59: Voltage source for controlling electron temperature

20: Cylinder

### BEST MODE FOR CARRYING OUT THE INVENTION

### Definition of Terms

The terms used in relation to the present invention will be defined, and the best embodiments of the invention will be described.

The term “fullerene” refers to carbon cluster substances having a closed cage structure represented by a chemical formula of Cₙ (n=60, 70, 76, 78, 80, 82, . . . ).

The term “fullerene derivative” refers to fullerene derivatives such as endohedral fullerenes, heterofullerenes, etc.

The term “endohedral fullerene” refers to fullerenes enclosing an atom in the hollow space of their cage-like structure.

The term “heterofullerene” refers to fullerenes where one or two or more constituent carbons are replaced by an atom(s) other than carbon.

The inventive method for manufacturing a fullerene derivative includes two different modes of operation, one being “fullerene plasma interaction” and the other “fullerene vapor impingement.”

The method based on “fullerene plasma interaction” includes introducing fullerene vapor into the flow of plasma comprised of the positive ions of an atom acting as a moiety in the production of a fullerene derivative generated in a plasma generating chamber as well as of electrons, so that the fullerenes have electrons attached thereto to become negative ions, and allowing the negative ions of fullerene to react with the positive ions of the atom to produce a fullerene derivative, and depositing the fullerene derivative onto a deposition substrate located downstream of the flow of plasma.

The method based on “fullerene vapor impingement” includes driving the flow of plasma comprised of the ions of an atom acting as a moiety in the production of a fullerene derivative against a deposition substrate located downstream of the flow of plasma, impinging, in the mean time, fullerene vapor discharged from a fullerene oven onto the deposition substrate, thereby allowing the ions of the atom to react with the fullerene molecule or fullerene ions to produce a fullerene derivative, and depositing the fullerene derivative on the deposition substrate.

(Method Based on Fullerene Plasma Interaction)

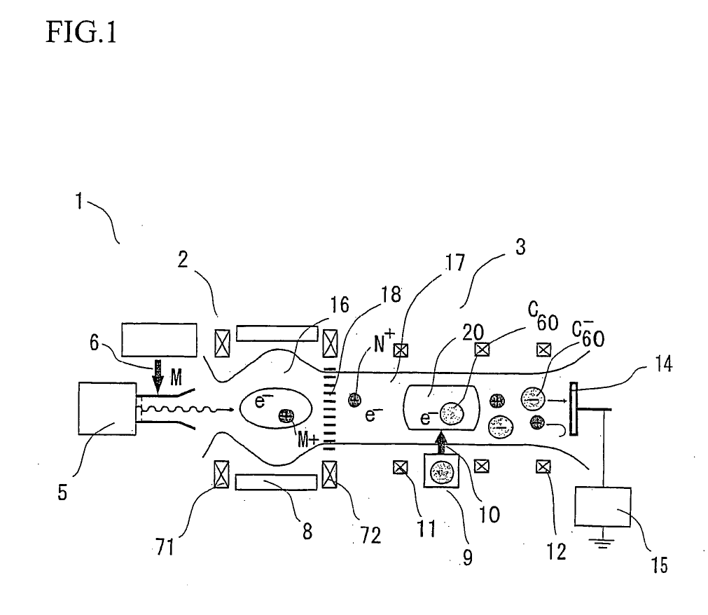

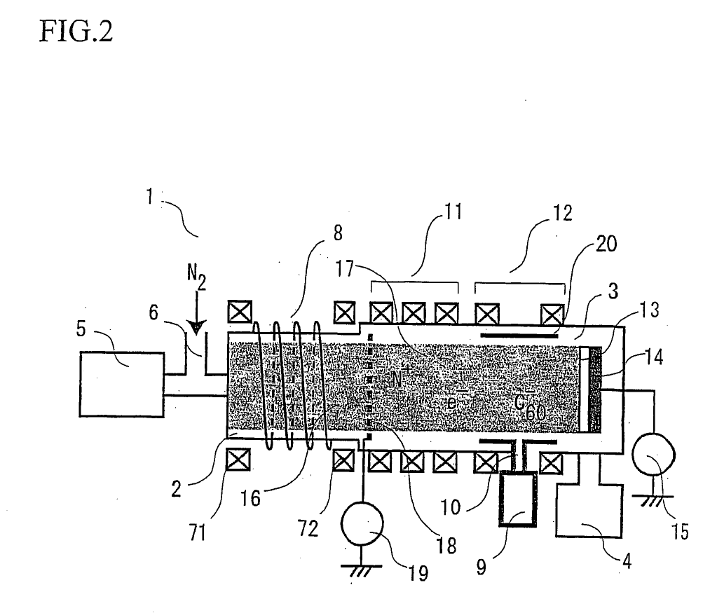

FIG. 1 is a schematic diagram outlining a system of the invention operating on fullerene plasma interaction. FIG. 2 is a sectional view of the inventive system operating on fullerene plasma interaction. Referring to FIGS. 1 and 2, the fullerene derivative manufacturing system 1 comprises a gas introducing port 6 for introducing gas M consisting of an atom acting as a moiety (for example, hydrogen or nitrogen) in the production of a fullerene derivative, a high electron temperature plasma generating chamber 2 where atom M is converted into M⁺, and a fullerene derivative generating chamber 3 including a control electrode 18 located downstream of the high electron temperature plasma generating chamber 2 and acting as an electron energy control means for controlling the electron energy of high electron temperature plasma to be in the range of 1 to 10 eV, fullerene introducing means for introducing fullerene into low electron temperature plasma 17, and a deposition substrate 14 upon which a fullerene derivative produced is allowed to deposit.

(Generation of High Electron Temperature Plasma)

The high electron temperature plasma generating chamber 2 is made of an insulating material (for example, quartz). The high temperature plasma generating chamber 2 is provided with a microwave generator 5 located upstream of gas introducing port 6 in terms of the flow of plasma, a pair of coils 71, 72 located around the external wall of high electron temperature plasma generating chamber 2 to form the mirror field which prohibits the dispersion of the ions M⁺ thus produced, and a four phase control helical antenna 8 wound around a gap between the coils 71 and 72.

The microwave generator 5 is preferably adjusted, if gas M consists of nitrogen, such that the frequency of generated microwave is around 2.45 GHz. The mirror ratio (Rm) of mirror field is preferably 1.2 to 3.0.

Coils 71, 72 are obtained by winding wires around the high electron temperature plasma generating chamber 2 in the form of annuli with a specified interval between them, and current is allowed to pass through the coils in the same direction. Then, strong magnetic fields are formed close to the coils 71, 72, and weak magnetic field is formed at the interval between the coils 71, 72. Since ions and electrons are recoiled in the presence of the strong magnetic field, they are temporarily restricted in a limited space to form a plasma there. Coils responsible for the formation of mirror field are not limited to the annular coils 71, 72 described above. For example, a single coil in which a wire takes a course like the seam of a base ball may be used instead. There is no limitation to circular.

The four phase control helical antenna (PMH antenna) 8 is a source for supplying radio frequency output (13.56 MHz, 2 kW at maximum) with the phases of multiple coil elements varied such that a great difference occurs between fields generated by different coil elements. Accordingly, plasma generated in high electron temperature plasma generating chamber 2 becomes highly dense throughout its extent, and thus the production efficiency of plasma constituents such as ions, radicals, etc, is enhanced, and the number of electrons attached to fullerenes sublimated into the fullerene derivative generating chamber 3 is increased.

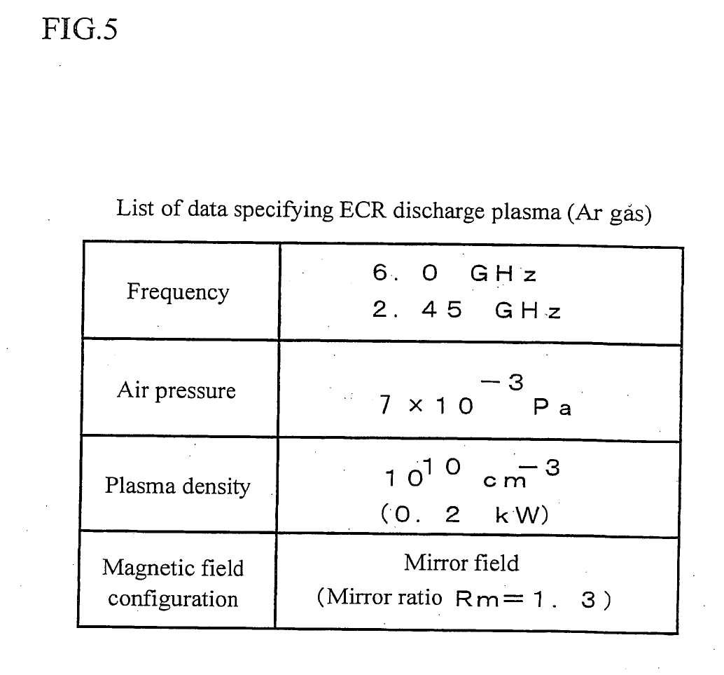

The condition under which generation of a high electron temperature plasma is achieved by exciting Ar gas is cited in FIG. 5.

According to a feature of the invention, it is possible to easily produce a high electron temperature plasma in high electron temperature plasma generating chamber 2 whose electron temperature is in the range of 15 to 50 eV. Accordingly, it is possible to efficiently derive monovalent nitrogen ions from neutral nitrogen molecule.

(Transfer of Plasma)

Fullerene derivative generating chamber 3 is provided with an electromagnetic coil 11. Plasma is confined axially along a uniform magnetic field (B=2 to 7 kG) generated by electromagnetic coil 11 in fullerene derivative generating chamber 3. Being axially confined by this magnetic field, plasma flowing from high electron temperature plasma generating chamber 2 forms the current of high density plasma. The electromagnetic coil 11 may have a supplementary electromagnetic coil 12 on its downstream side with a different magnetic field as shown in FIG. 2. Fullerene derivative generating chamber 3 is further provided with a fullerene sublimation oven 9 acting as a fullerene introducing means.

(Control of Electron Temperature, and Generation of Fullerene Ion)

It is possible by providing a control electrode 18 to a site just downstream of high electron temperature plasma generating chamber 2 to easily generate 10 eV or lower of a low electron temperature 17 (preferably 5 eV or lower). The potential of control electrode 18 may be varied.

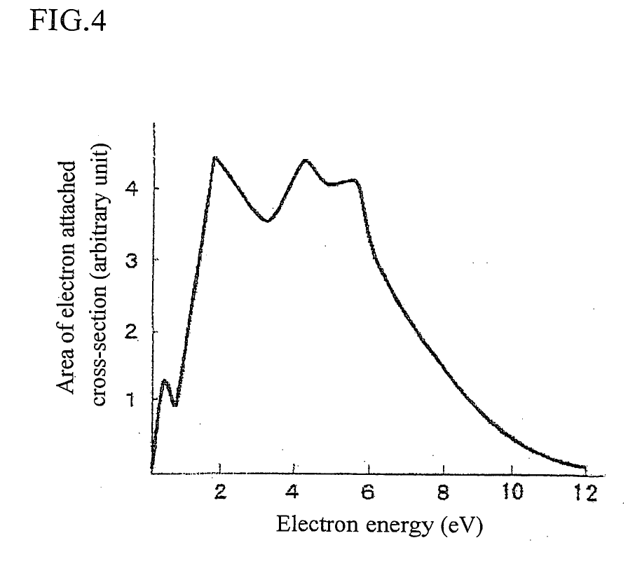

For example, it is possible by applying a negative voltage to control electrode 18 to reduce the energy of electrons. When the energy of electrons is made 10 eV or lower, electrons in low electron temperature plasma 17 can readily attach to fullerenes. Then, it is possible to obtain negatively charged fullerenes ion at high concentration. Incidentally, the energy of electrons is preferably 1 eV, because electrons whose energy level is below this lower limit are hard to control. FIG. 4 is a graph representing the cross-sectional area of electron attached fullerene as a function of electron energy.

If an electron whose energy level is higher than 20 eV collides against a fullerene, it will purge an electron from the fullerene, thereby turning the fullerene into a positive ion. Since the positive ion of fullerene is reluctant to react with a positive ion of an atom acting as a moiety. For the generation of a fullerene derivative, it is desirable to reduce the positive ions of fullerene. It is possible by reducing the energy of electrons to 10 eV or lower to inhibit the production of positive ions of fullerene.

(Deposition Substrate)

The fullerene derivative generating chamber 3 is further provided with a deposition substrate 14 close to the downstream end of plasma in the chamber. The deposition substrate 14 comprises a potential body serving also as an ion velocity control means. A positive bias voltage is preferably applied to deposition substrate 14. When a positive bias voltage is applied to the deposition substrate, the difference of the velocity of negative ions of a fullerene relative to the velocity of positive ions of a modifier atom is reduced. It is possible by reducing the relative difference between the velocities of two involved ions to facilitate the coulomb interaction between the two kinds of ions, thereby increasing the likeliness that the atom will enter into the internal space of fullerene or replace a carbon atom constituting fullerene. Fullerene derivative generating chamber 3 may be further provided with a probe (not shown) for monitoring the property of plasma there. For example, it is preferable to generate a fullerene derivative by adjusting the velocities of fullerene ions and ions of a modifier atom based on the monitoring result provided by the probe. It is also preferable to reduce the relative difference between the two kinds of ions by adjusting a bias voltage applied to deposition substrate 14.

For example, to produce N@C60 as a fullerene derivative, the bias voltage applied to the deposition substrate is preferably not less than 0 V but not more than 40 V.

The diameter of deposition substrate and diameter of plasma flow may be determined as appropriate depending on the size of the system, and the kind of a target fullerene derivative. It is possible to vary the diameter of plasma flow by adjusting the intensity of magnetic field evoked by electromagnetic coils 11, 12.

(Cooling Means)

Fullerene derivative generating chamber 3 is further provided with cooling means (not shown) around its external wall. The inner wall of fullerene derivative generating chamber 3 is cooled by means of cooling means so that the inner wall of generating chamber 3 can trap neutral gas molecules. It is possible by allowing neutral gas molecules to trap on the inner wall to eliminate impurities from plasma, thereby producing plasma essentially free from impurities which in turn allows highly pure fullerene derivatives to deposit on the deposition substrate 14. The temperature of the inner wall of fullerene derivative chamber 3 is preferably kept at room temperature or lower, more preferable 0° C. or lower. When the inner wall is kept at a temperature within the above range, it becomes easy to trap neutral molecules, and thus is possible to produce highly pure fullerene derivatives at high yield.

(Cylinder for Renewed Sublimation)

A copper cylinder 20 is provided in the course of low electron temperature plasma 17 in such a configuration as to cover the flow of plasma. The cylinder 20 is equipped with a fullerene introducing pipe 10 through which fullerene is introduced into the flow of plasma. The cylinder 20 is preferably heated to a temperature allowing fullerene to be sublimated again. Specifically, the cylinder is preferably heated to 400 to 600° C. Fullerenes, which are introduced into cylinder 20 to enter into plasma there, but are adsorbed to the inner wall of cylinder not being ionized in plasma, are sublimated again therefrom.

The internal radius of cylinder 20 is preferably R+5 mm or higher, when R represents the radius of plasma flow.

If the internal radius of cylinder 20 is less than R+5 mm, cylinder 20 will interact with plasma flow so much that its ability to hold plasma will be degraded and the yield of fullerene derivative reduced.

If the internal radius of cylinder 20 is beyond the above range, the entire system will be enlarged, and entrapment of plasma by cylinder 20 will be impaired. Accordingly, the internal radius of cylinder 20 is preferably kept not more than R+5 cm. A cylinder 20 whose internal radius is kept not more than R+5 cm will be able to safely entrap plasma within its space. More preferably, the internal radius of cylinder 20 is kept not more than R+2 cm. A cylinder whose internal radius is not more than R+2 cm will allow the density of plasma to be sufficiently high which, in turn, will increase the likeliness of particles of interacting with each other, thus leading to the higher yield of fullerene derivatives.

The velocity of fullerene introduction may be adjusted by controlling the temperature rise over time of oven 9 for fullerene sublimation. The temperature rise over time in question is preferably 100° C./min or higher. The upper limit of temperature rise over time corresponds to the maximum attainable temperature rise at which no bumping will occur.

(Vacuum Vessel)

Generation of a fullerene derivative according to the invention occurs in a vacuum vessel. High electron temperature plasma generating chamber 2 and fullerene derivative generating chamber 3 communicate with each other, and both chambers can be evacuated with a vacuum pump 4.

The two chambers have preferably an initial vacuum of 10⁻³ Pa or lower, more preferably 10⁻⁶ Pa or lower.

The surfaces of vacuum vessels and cylinder 20 are preferably coated with inert membranes made of chromium oxide (inert membranes essentially free from iron oxides). Furthermore, preferably the membrane hardly permits the adsorption of oxygen and moisture, or allows the ready escape of those matters, even if those matters are adsorbed to the membrane. With regard to gas introduced into the chamber, its content of impurities (particularly, moisture, oxygen) is preferably kept at 10 ppb or lower, more preferably 1 ppb or lower, still more preferably 100 ppt or lower.

(Method Based on Fullerene Vapor Impingement)

In contrast with the system operating on fullerene plasma interaction, a fullerene derivative manufacturing system operating on fullerene vapor impingement impinges fullerene vapor directly to a deposition substrate. At the same time, plasma containing the ions of a modifier atom is applied to the deposition substrate. Fullerene derivatives are generated as a result of the collision of the ions of a modifier atom with fullerenes, instead of the coulomb attraction-based interaction between the two reactants. The energy with which the ions of a modifier atom collide with fullerenes can be freely adjusted by varying the negative bias voltage applied to the deposition substrate. The method based on fullerene vapor impingement increases the likeliness of the ions of a modifier atom to collide with fullerenes more effectively than is possible with the method based on fullerene plasma interaction.

### FIRST ILLUSTRATIVE EXAMPLE OF THE METHOD BASED ON FULLERENE VAPOR IMPINGEMENT

With regard to a system operating on fullerene vapor impingement, generation of high electron temperature plasma, transfer of plasma, cooling by cooling means, and construction of a vacuum chamber occur in the same manner as in the system operating on fullerene plasma interaction, and detailed explanation thereof has been given above. Therefore, their explanation will be omitted.

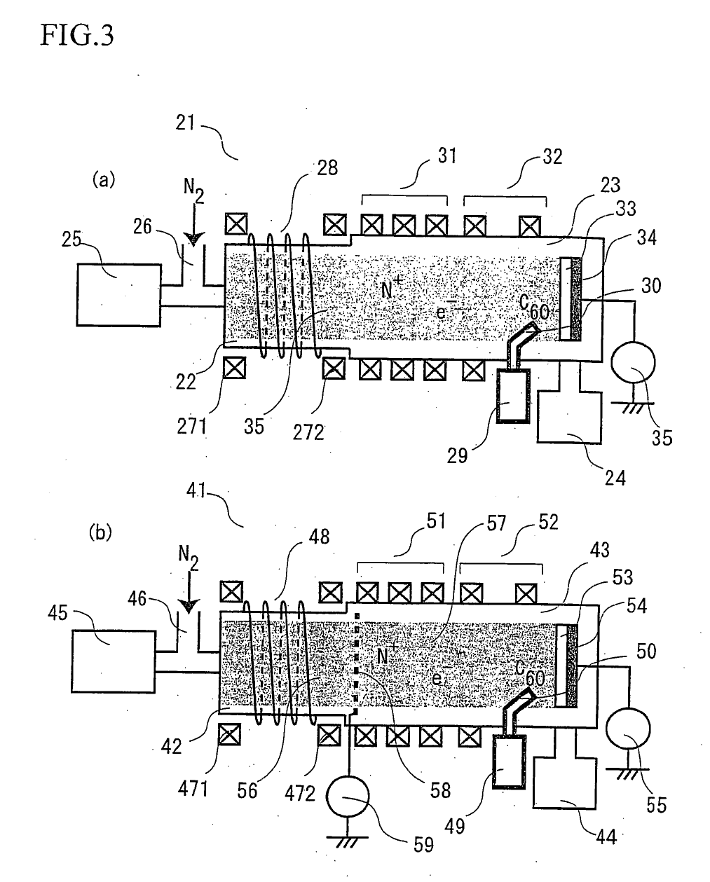

FIG. 3(a) is a sectional view of a first illustrative example of an inventive system for manufacturing a fullerene derivative operating on fullerene vapor impingement. Referring to FIG. 3(a), a fullerene derivative manufacturing system 21 comprises a gas introducing port 26 through which gas M comprising a dopant atom is introduced into the system, a high electron temperature plasma generating chamber 22 where the dopant atom M of the gas is turned into M⁺, and a fullerene derivative generating chamber 23 where both a high electron temperature plasma 35 generated in plasma generating chamber 22 and fullerene vapor sublimated at a fullerene sublimating oven 29 are allowed to impinge onto a deposition substrate 34 so that resulting fullerene derivatives deposit there.

Fullerene molecules or fullerene ions ejected through fullerene gas introducing port 30 are allowed to collide with the ions of modifier atom of plasma 35 on deposition substrate 34, thereby producing fullerene derivatives. The energy with which the ions of modifier atom collide with fullerenes can be adjusted by varying the negative bias voltage applied to the deposition substrate. According to the system, it is not necessary to turn fullerenes into negative ions, and thus implementation of an electrode which is normally required for controlling the electron temperature of plasma is not necessarily needed.

### SECOND ILLUSTRATIVE EXAMPLE OF THE METHOD BASED ON FULLERENE VAPOR IMPINGEMENT

FIG. 3(b) is a sectional view of a second illustrative example of an inventive system for manufacturing a fullerene derivative operating on fullerene vapor impingement. Referring to FIG. 3(b), a fullerene derivative manufacturing system 41 comprises a gas introducing port 46 through which gas M comprising a dopant atom is introduced into the system, a high electron temperature plasma generating chamber 42 where the dopant atom M of the gas is turned into M⁺, a control electrode 58 acting as electron energy controlling means which is located at the downstream side of high electron temperature plasma generating chamber 42 in terms of the flow of plasma, and which is for keeping the electron energy of high electron temperature plasma in the range of 1 to 10 eV, and a fullerene derivative generating chamber 43 where both a low electron temperature plasma 57 derived from plasma flowing from high electron temperature plasma generating chamber 42 and fullerene vapor sublimated at a fullerene sublimating oven 49 are allowed to impinge onto a deposition substrate 54 so that resulting fullerene derivatives deposit there.

According to the fullerene derivative manufacturing system representing the second illustrative example, it is possible to accelerate the movement of the ions of a modifier atom towards deposition substrate 54 and decelerate electrons by applying a negative voltage to the control electrode 58. Namely, it is possible according to the system to adjust the energies of the ions of modifier atom and electrons of plasma to levels suitable for the production of fullerene derivatives. Thus, according to the system, it is possible to control the process responsible for the production of fullerene derivatives not only through a bias voltage applied to the deposition substrate but also through a bias voltage applied to the control electrode, controllability of the process is further improved.

(Atom Responsible for the Derivatization of Fullerene)

The above embodiments have been described on the premise that gas M mainly comprises nitrogen. According to the inventive system for manufacturing a fullerene derivative, and method employed by the system, gas M may comprise hydrogen, argon, helium or neon, that is, those atoms may act as a moiety in the production of a fullerene derivative. Gas M may comprise a boron-based gas such as BF₃, or a mixture gas containing a boron-based gas and nitrogen. In these cases, boron, or both boron and nitrogen may be responsible for the formation of fullerene derivatives. For this purpose it is also possible to use the inventive system for manufacturing a fullerene derivative, and method employed by the system.

The inventive system for manufacturing a fullerene derivative, and method employed by the system are characterized by their capability of exciting gas molecules comprised of a modifier atom via high temperature electrons. The system and method are particularly effective in the production of a fullerene derivative in which a modifier atom requires a high energy for its conversion into ion, such as nitrogen. Nitrogen-based fullerene derivatives are expected to have promising applications in various fields, for example, an endohedral fullerene N@C₆₀ as a material of quantum computer, and C₅₉N and C₅₈BN as a superconductive and ultra-hard material.

### EXAMPLE

(Illustrative Production of Nitrogen-Based Fullerene Derivative)

To produce heterofullerene C₅₉N or a fullerene derivative obtained by replacing a carbon atom constituting a fullerene by a nitrogen atom by N, a system as shown in FIG. 3(b) was used where electromagnetic coils are wound around the external wall of a cylindrical stainless steel vessel.

A vacuum vessel connecting a high electron temperature plasma generating chamber 42 and a fullerene derivative generating chamber 43 was evacuated to 1.0×10⁻⁴ Pa, and the electromagnetic coils were activated to generate a magnetic field whose intensity is equal to 0.13 T. Nitrogen gas was introduced through a gas introduction port 46 into high electron temperature plasma generating chamber 42 at a rate of 10 sccm. Then, nitrogen atoms were excited via μ wave having a frequency of 2.45 GHz and power of 800 W and coils were activated to generate a mirror field having a mirror ratio of 2.4 so that a nitrogen plasma having an electron temperature of 15 eV was generated. The nitrogen plasma had its electron voltage reduced to 2 eV because of a bias voltage −20 V being applied to a control electrode 58. The thus produced low electron temperature plasma 57 was introduced into a fullerene derivative generating chamber 43 to be driven against a deposition substrate 54. At the same time, vapor consisting of fullerene C₆₀ sublimated at a fullerene sublimating oven 49 heated to 580° C. was allowed to impinge onto the deposition plate 54. A bias voltage −30V was applied to the deposition substrate 54, so that a thin film containing hetrofullerenes such as C₅₉N was formed on the surface of the substrate. Reaction products were allowed to deposit for two hours, and a thin film having a thickness of 3 μm was formed on the substrate.

(Mass Spectroscopy of Deposition Film)

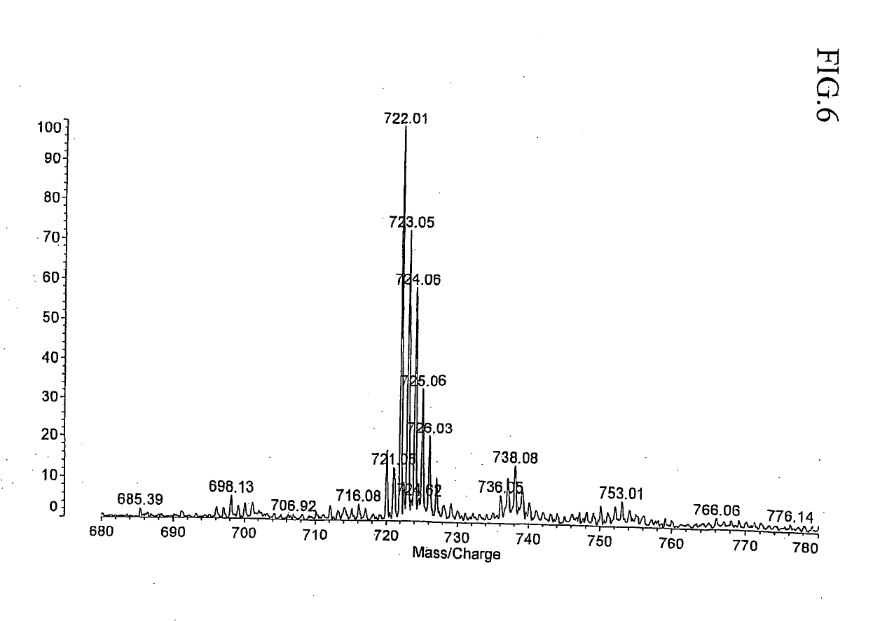

FIG. 6 represents mass spectroscopic data of a deposition membrane obtained as a result of the illustrative production of nitrogen-based fullerene derivative as described above. There are a peak at the mass number of 720 corresponding to C₆₀ and another peak at the mass number of 722 corresponding to C₅₉N. The intensity ratio of those peaks or I(722)/I(720) is about 5 when VG is −20 V and VB −30 V.

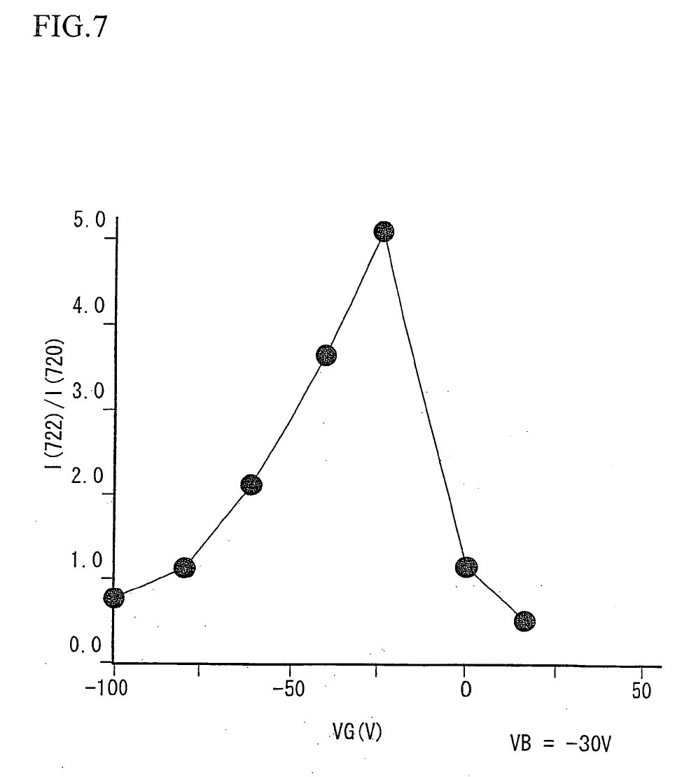

FIG. 7 plots changes of the intensity ratio I(722)/I(720) when VB was kept at −30V and VG was altered from −100 V to +20 V, based on the mass spectroscopy of a deposition membrane. It is obvious from the graph that the efficiency of C₅₉N production is the maximum when VG=−20 V.

### INDUSTRIAL APPLICABILITY

As is obvious from the above description, the inventive system for manufacturing a fullerene derivative, and method employed by the system are useful for efficiently producing fullerene derivatives which are expected to have promising applications in the fields such as electronics and medicine. They are particularly useful for the production of fullerene derivatives incorporating an atom which requires a high energy for its conversion into ion.

1-11. (canceled)

12. A system for manufacturing a fullerene derivative comprising means for generating high electron temperature plasma whose electron energy is kept 15 to 50 eV in order to generate a positive monovalent ion M⁺ from a gas containing an atom M which acts as a moiety in the production of a fullerene derivative; fullerene introducing means for introducing a fullerene into plasma comprised of M⁺ and electrons to produce a fullerene ion; and a deposition substrate where a fullerene derivative produced as a result of reaction between the fullerene ion and M⁺ is allowed to deposit.

13. A system for manufacturing a fullerene derivative comprising means for generating high electron temperature plasma whose electron energy is kept 15 to 50 eV in order to generate a positive monovalent ion M⁺ from a gas containing an atom M which acts as a moiety in the production of a fullerene derivative; fullerene introducing means for introducing a fullerene; and a deposition substrate, wherein plasma comprised of M⁺ is driven against the deposition substrate while at the same time fullerene ejected via the fullerene introducing means is allowed to impinge onto the deposition substrate so that M⁺ and fullerene react with each other to produce a fullerene derivative which deposits on the deposition substrate.

14. The system as described in claim 12 for manufacturing a fullerene derivative wherein the high electron temperature plasma generating means comprises at least a pair of coils for generating a mirror field which prohibits the dispersion of positive ions produced.

15. The system as described in claim 13 for manufacturing a fullerene derivative wherein the high electron temperature plasma generating means comprises at least a pair of coils for generating a mirror field which prohibits the dispersion of positive ions produced.

16. The system as described in claim 12 for manufacturing a fullerene derivative wherein the high electron temperature plasma generating means comprises at least a pair of coils for generating a mirror field which prohibits the dispersion of positive ions produced, and a four phased helical antenna located between the pair of coils.

17. The system as described in claim 13 for manufacturing a fullerene derivative wherein the high electron temperature plasma generating means comprises at least a pair of coils for generating a mirror field which prohibits the dispersion of positive ions produced, and a four phased helical antenna located between the pair of coils.

18. The system as described in claim 12 for manufacturing a fullerene derivative wherein the high electron temperature plasma generating means comprises gas introducing means, a microwave generator for exciting gas to produce positive ions therefrom, a pair of coils for generating a mirror field which prohibits dispersion of the positive ions produced, and a four phased helical antenna located between the pair of coils.

19. The system as described in claim 13 for manufacturing a fullerene derivative wherein the high electron temperature plasma generating means comprises gas introducing means, a microwave generator for exciting gas to produce positive ions therefrom, a pair of coils for generating a mirror field which prohibits dispersion of the positive ions produced, and a four phased helical antenna located between the pair of coils.

20. The system as described in claim 12 for manufacturing a fullerene derivative further comprising electron energy control means for controlling the energy of electrons in a plasma to be in the range of 1 to 10 eV, the electron energy control means being located downstream of the high electron temperature plasma generating means in terms of the flow of plasma.

21. The system as described in claim 20 for manufacturing a fullerene derivative wherein the electron energy control means controls the energy of electrons by applying a control voltage to an electrode located upstream of the fullerene introducing means in terms of the flow of plasma.

22. The system as described in claim 12 for manufacturing a fullerene derivative.
